(19) United States
(12) Patent Application Publication
(10) Pub. No.: US 2002/0190667 A1
(43) Pub. Date: Dec. 19, 2002

(54) Discharge lamp apparatus and projector using the same

(76) Inventors: Masamichi Ishikawa, Hekinan-shi (JP); Koichi Kato, Toyoake-shi (JP)

Correspondence Address: LAW OFFICES OF DAVID G. POSZ, 2000 L STREET, N.W., SUITE 200, WASHINGTON, DC, 20036, US

(21) Appl. No.: 10/170,368

(22) Filed: Jun. 14, 2002

(30) Foreign Application Priority Data
Jun. 14, 2001 (JP) 2001-180217
Nov. 9, 2001 (JP) 2001-344293

(51) Int. Cl. H05B 37/02

(52) U.S. Cl. 315/291; 315/307

(57) ABSTRACT

In a discharge lamp apparatus, a metal case has a blind-end box-like configuration, and a ceramic board and a power MOS transistor of a DC/DC converter are mounted on an internal bottom surface of the metal case while a printed circuit board is mounted on an opening side of the metal case in a state separated from the power MOS transistor and the ceramic board in a thickness direction of the discharge lamp apparatus. On the ceramic board, there are mounted a discharge lamp control circuit for controlling power to a discharge lamp by switching the power MOS transistor and an H bridge circuit for forming a voltage to be applied to the discharge lamp into a pulse shape, and on the printed circuit board, there are mounted a high-tension coil for generating a voltage to be applied to the discharge lamp, and others. With this construction, the heat developed in the discharge lamp control circuit, the H bridge circuit and the power MOS transistor conducts efficiently to the metal case.

### BACKGROUND OF THE INVENTION

1) Field of the Invention

The present invention relates to a discharge lamp apparatus for lighting a discharge lamp, and a projector using the discharge lamp apparatus.

2) Description of the Related Art

A discharge lamp apparatus, which generates a voltage to be applied to a discharge lamp and controls the generated voltage, is equipped with a DC/CD converter, a discharge lamp control circuit and a high-voltage generating circuit. The DC/DC converter is made to transform an output voltage by switching an input voltage through the use of a power device, while the discharge lamp control circuit is made to control the electric power of the discharge lamp through the on/off control of the power device of the DC/DC converter. The high-voltage generating circuit is made to generate a discharge voltage at the time of starting to light the discharge lamp (The “discharge voltage at the starting to light a discharge lamp” will be referred to hereinafter as a “starting voltage”). In a case in which the DC/DC converter, the discharge lamp control circuit and the high-voltage generating circuit are located two-dimensionally on the same plane, there is a problem in increases in the lengths of the discharge lamp apparatus in its longitudinal and transverse directions. In addition, since the discharge lamp control circuit is principally composed of semiconductor devices, an operating temperature rises due to the heat generated from the power device of the DC/DC converter, which easily leads to a malfunction.

In the discharge lamp apparatus disclosed in Japanese Unexamined Patent Publication No. HEI 7-14683, a discharge lamp control circuit and a power device are placed on an internal surface of a metal case while a high-voltage generating circuit is located on an external surface of the metal case. In this construction, since the discharge lamp control circuit, the power device and the high-voltage generating circuit are arranged in one of three-dimensional directions forming a thickness direction of the discharge lamp apparatus, it is possible to shorten the lengths of the discharge lamp apparatus in its longitudinal and transverse directions. Moreover, since the heat developed in the discharge lamp control circuit and the power device conducts to the metal case and radiates from the metal case, thus preventing the heat of the power device from conducting to the discharge lamp control circuit.

However, there is a possibility that the heat developed in the power device and the discharge lamp control circuit placed on the internal surface of the metal case conducts to the high-voltage generating circuit located on the external surface of the metal case, thus resulting in impairing the performance or durability of parts of the high-voltage generating circuit, such as high-voltage coils.

### SUMMARY OF THE INVENTION

It is therefore an object of the present invention to provide a discharge lamp apparatus having short longitudinal and transverse lengths and high heat radiation efficiency.

Another object of the invention is to provide a small-sized projector having high heat radiation efficiency.

For these purposes, in a discharge lamp apparatus according to an aspect of the present invention, electric parts constituting a DC/DC converter, a high-voltage generating circuit and a discharge lamp control circuit are placed either on a bottom surface or an opening side in the interior of a metal case. Since the electric parts of the discharge lamp apparatus are located in a thickness direction constituting one of three-dimensional directions of the discharge lamp apparatus, it is possible to shorten accordingly the lengths of the discharge lamp apparatus in its longitudinal and transverse directions forming the other two directions (two-dimensional directions) of the three dimensional directions.

In addition, a power device is placed on a bottom surface in the interior of the metal case formed into a blind-end box-like configuration while a high-tension coil is placed on an opening side of the metal case separated from the power device. Since the power device and the high-tension coil are separated from each other in a thickness direction of the discharge lamp apparatus so that the heat developed in the power device conducts (is conducted) to the metal case and radiates from the metal case, thus preventing the heat of the power device from conducting to the high-tension coil. Moreover, even if the discharge lamp control circuit is located either on the bottom surface in the interior of the metal case or on the opening side thereof, the heat developed in the power device is hard to conduct to the discharge lamp control circuit. The high-tension coil and the discharge lamp control circuit can operate normally because of preventing increases in the operating temperatures of the high-tension coil and the discharge lamp control circuit principally made up of semiconductor devices, thus leading to lengthening the lifetime thereof.

In the discharge lamp apparatus according to another aspect of the present invention, the discharge lamp control circuit is placed on the bottom surface in the interior of the metal case, so the heat developed in the discharge lamp control circuit conducts to the metal case and radiates therefrom. Accordingly, an increase in the operating temperature of the discharge lamp control circuit is preventable. Moreover, since the discharge lamp control circuit and the high-tension coil are separated from each other in the thickness direction to prevent the heat of the discharge lamp control circuit from conducting to the high-tension coil, thus preventing the increase in the operating temperature of the high-tension coil. This causes the high-tension coil and the discharge lamp control circuit to operate normally and lengthening the lifetime thereof.

In the discharge lamp apparatus according to a further aspect of the present invention, the high-tension coil is mounted on a surface of a board on an opening side opposite to a surface, which is in opposed relation to the power device and the discharge lamp control circuit, to be faced toward the exterior of the metal case, thus preventing the high-tension coil from being heated by the heat in the power device, the discharge lamp control circuit and the metal case.

In the discharge lamp apparatus according to a further aspect of the present invention, air flows in the interior and exterior of the metal case through a vent made in at least one of the metal case and the opening side board, thus preventing increases in the temperatures of the electric parts of the discharge lamp apparatus. Accordingly, the discharge lamp apparatus can operate normally and have a prolonged lifetime. Moreover, since it is possible to prevent the temperature increase of the electric parts even if the electric parts constituting the discharge lamp apparatus are spaced close to each other, the size reduction of the discharge lamp apparatus becomes feasible.

In the discharge lamp apparatus according to a further aspect of the present invention, in the opening side board on which placed is a ring-like DC/DC transformer which has a high operating temperature due to a large power loss, a vent is made at a portion corresponding to a central portion of the DC/DC transformer. Air passes through this vent, thus effectively preventing the operating temperature increase of the DC/DC transformer and the electric parts around the DC/DC transformer.

Unlike the starting voltage of a discharge lamp for use in headlights of motor vehicles, the starting voltage of a discharge lamp to be used for a projector according to a further feature of the present invention which is made to project an image onto a screen or the like by illumination from the discharge lamp becomes low. Since the voltage in a circuit of the discharge lamp apparatus is low at the time of starting to light the discharge lamp, noises are less developable from the high-tension generating circuit or the power device. Accordingly, there is no need to shield the high-tension generating circuit or the power device, which reduces the number of parts and shortens the lengths of the discharge lamp apparatus in its longitudinal and transverse directions. Moreover, through the use of the discharge lamp apparatus according to any one of the aspects or features of the present invention, the heat generated from the discharge lamp apparatus conducts from the metal case to an accommodating case to radiate from the accommodating case to the external. This suppresses the heating in the accommodating case, and controls the temperature increase in the interior of the projector even if the parts of the projector accommodated in the accommodating case are spaced close to each other. Accordingly, the size reduction of the projector becomes feasible.

### BRIEF DESCRIPTION OF THE DRAWINGS

Other objects and features of the present invention will become more readily apparent from the following detailed description of the preferred embodiments taken in conjunction with the accompanying drawings in which:

FIG. 1A is a cross-sectional view showing a discharge lamp apparatus according to a first embodiment of the present invention;

FIG. 1B is an illustration of a section indicated by an arrow B in FIG. 1A;

FIG. 1C is an illustration of a section indicated by an arrow C in FIG. 1A;

FIG. 2A illustratively shows a projector according to the first embodiment;

FIG. 2B is a cross-sectional view taken along a line B-B of FIG. 2A;

FIG. 3 is an illustration of a circuit of the discharge lamp apparatus according to the first embodiment;

FIG. 4 is a cross-sectional view showing a discharge lamp apparatus according to a second embodiment of the prevent invention;

FIG. 5 is an illustration of a circuit of a discharge lamp apparatus according to a third embodiment of the present invention;

FIG. 6A is a cross-sectional view showing a discharge lamp apparatus according to a fourth embodiment of the present invention;

FIG. 6B is an illustration of a section indicated by an arrow B in FIG. 6A;

FIG. 6C is an illustration of a section indicated by an arrow C in FIG. 6A;

FIG. 7A illustratively shows a projector according to the fourth embodiment; and

FIG. 7B is a cross-sectional view taken along a line B-B of FIG. 7A.

### DESCRIPTION OF THE PREFERRED EMBODIMENTS

Embodiments of the present invention will be described hereinbelow with reference to the drawings.

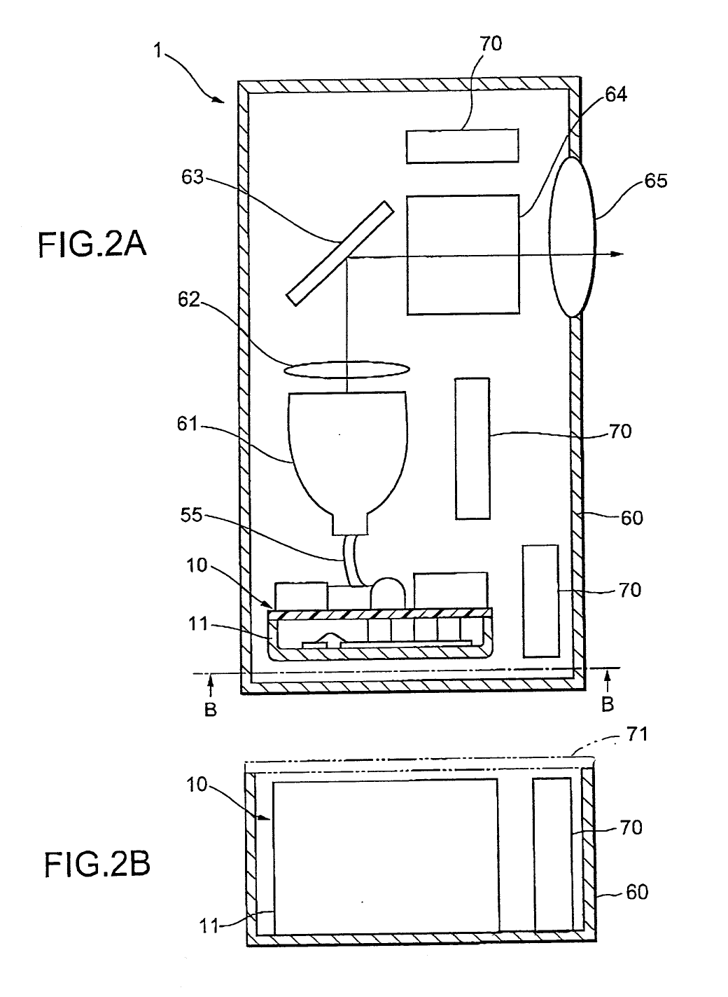

(First Embodiment) FIG. 2 is an illustration of a projector using a discharge lamp apparatus according to a first embodiment of the present invention.

A projector 1, serving as projecting equipment, accommodates a discharge lamp apparatus 10, a discharge lamp 61, a condensing lens 62, a mirror 63, a liquid crystal panel 64, a projecting lens 65 and a plurality of cooling fans 70 in an accommodating case 60. the apparatus in the accommodating case 60 is covered with a cover. The shorter one of the longitudinal and transverse directions of the discharge lamp apparatus 10 coincides or agrees with the vertical direction of the projector 1, and the discharge lamp is placed in the thickness direction of the discharge lamp apparatus 10. The discharge lamp apparatus 10 and the discharge lamp 61 are electrically connected to each other through a high-tension-proof cord 55, and the discharge lamp 61 emits light upon receipt of a voltage from the discharge lamp apparatus 10. The illuminating light emitted from the discharge lamp 61 is condensed through the condensing lens 62 and is direction-changed by the mirror 63 to pass through the liquid crystal panel 64 and the projecting lens 65, thereby projecting an image on the liquid crystal panel 64 onto a screen (not shown). The discharge lamp apparatus 10 is mounted on the accommodating case 60 in a state where a side surface of a metal case 11 thereof is brought into contact with a bottom surface in the interior of the accommodating case 60.

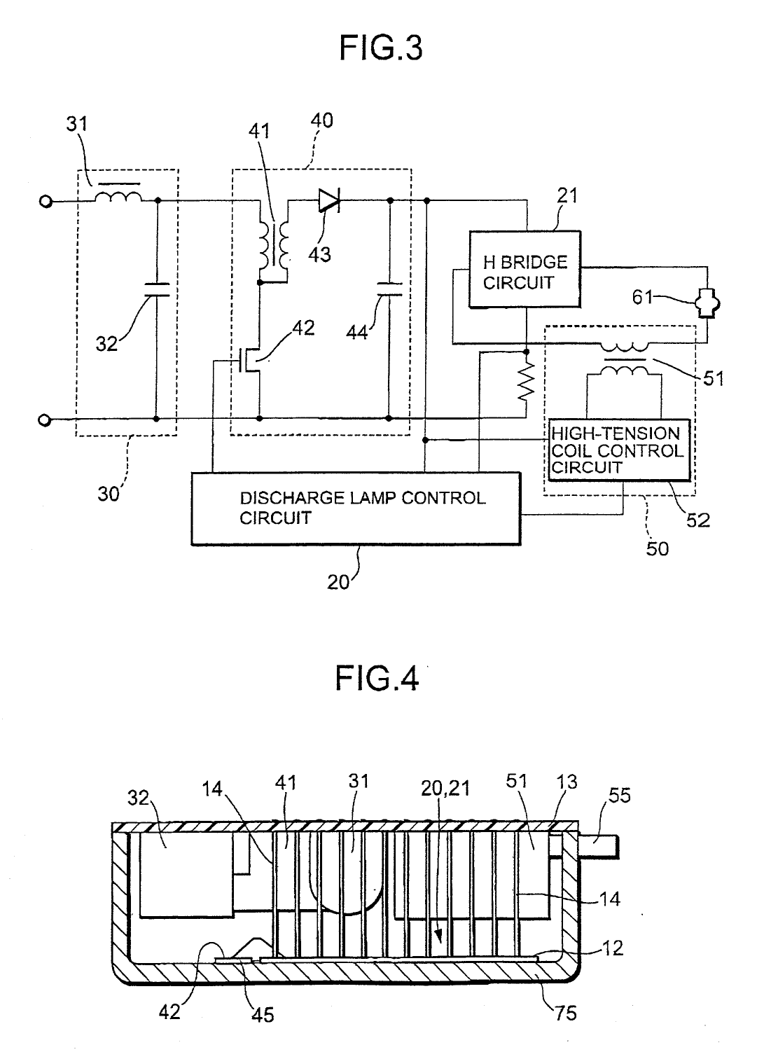

FIG. 3 is an illustration of an arrangement of a circuit of the discharge lamp apparatus 10.

The discharge lamp apparatus 10 includes a discharge lamp control circuit 20, an H bridge circuit 21, a filter circuit 30, a DC/DC converter 40 and a high-tension generating circuit 50. The discharge lamp control circuit 20 comprises semiconductor devices designed to control electric parts of the discharge lamp apparatus 10. The H bridge circuit 21 is a circuit for switching a power MOS transistor in accordance with a switching signal given from the discharge lamp control circuit 20 to form a voltage to be applied to the discharge lamp 61 into a pulse shape. The filter circuit 30 is composed of an inductor 31 and an electrolytic capacitor 32 to smooth a power supply voltage from an AC/CD converter (not shown).

The DC/DC converter 40 is made up of a DC/DC transformer 41, a power MOS transistor 42 functioning as a power device, a diode 43 and a capacitor 44, and is for stepping up the power supply voltage. The power to be applied from the DC/DC converter 40 to the discharge lamp 61 is controllable in a manner that the discharge lamp control circuit 20 controls the duty ratio of a switching signal to be applied to the power MOS transistor 42. The diode 43 and the capacitor 44 rectifies and smoothes an induced voltage developing on the secondary coil side of the DC/DC transformer 41.

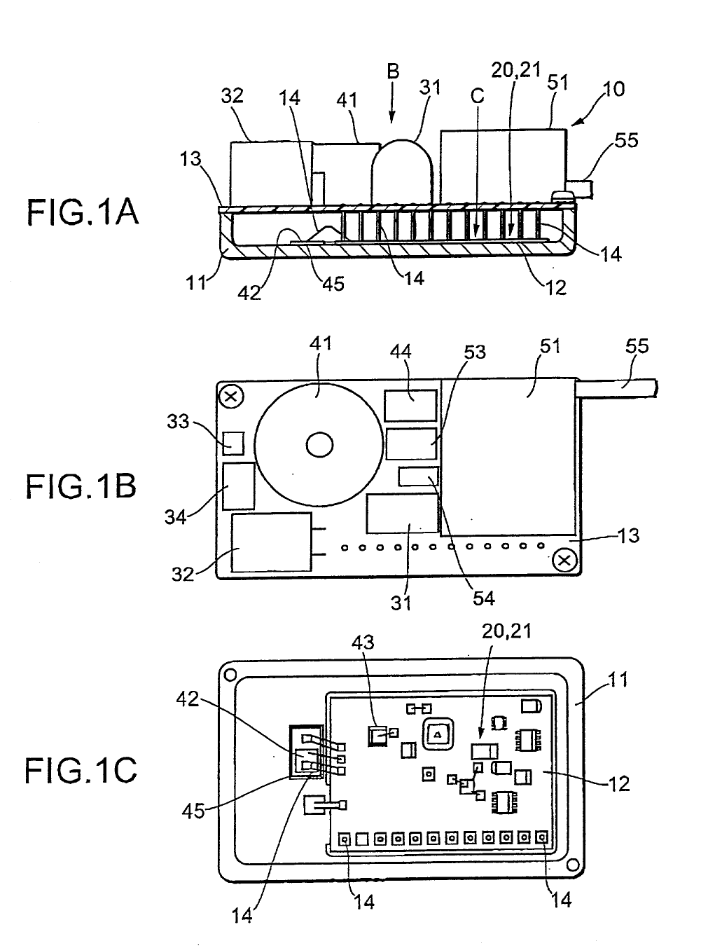

The high-tension generating circuit 50 is composed of a high-tension coil 51 and a high-tension coil control circuit 52. The high-tension coil 51 is made to generate a starting voltage for the discharge lamp 61. The high-tension coil control circuit 52 includes a capacitor 53, shown in FIG. 1, which is charged with a current flowing through the primary coil side of the high-tension coil 51, and further includes thyristor 54 for switching the discharge from the capacitor 53.

In FIGS. 1A to 1C, the metal case 11 has, for example, an aluminum-made blind-end box-like configuration, and a ceramic board 12 serving as a bottom side board and the power MOS transistor 42 are mounted on a bottom surface in the interior of the metal case 11. A printed circuit board 13, serving as an opening side board, is set through screws or the like to the opening side of the metal case 11 in a state separated from the power MOS transistor 42 and the ceramic board 12.

The ceramic board 12 holds the discharge lamp control circuit 20, the power MOS transistor of the H bridge circuit 21 and the diode 43 of the DC/DC converter 40. It is also possible that the power MOS transistor 42 is mounted on the ceramic board 12. It is also acceptable that the ceramic board 12 is constructed as a printed circuit board and the power MOS transistor 42 is mounted on the same printed circuit board. The power MOS transistor 42 is made in the form of a bare chip, and is attached to the metal case 11 through a heat sink 45 made of an insulating material. It is also appropriate that, in place of the bare chip power MOS transistor 42, a molded and packaged type power MOS transistor is mounted directly on the bottom surface in the interior of the metal case 11. The ceramic board 12, the power MOS transistor 42 and the printed circuit board 13 are electrically connected through lead wires to each other.

On a surface of the printed circuit board 13 opposite to a surface which is in opposed relation to the power MOS transistor 42, the discharge lamp control circuit 20 and the H bridge circuit 21, there are mounted the inductor 31, the electrolytic capacitor 32, an input signal connector 33, a power supply connector 34, the DC/DC transformer 41, the capacitor 44, the high-tension coil 51, the capacitor 53 and the thyristor 54.

The discharge lamp 61 for use in projecting equipment such as the projector 1 has a low starting voltage and, hence, noises are hard to generate from the power MOS transistor 42 and the high-tension coil 51. For this reason, the power MOS transistor 42 and the high-tension coil 51 are not covered with a seal material which can cut off noises.

The heat generated from the discharge lamp control circuit 20 and the H bridge circuit 21 mounted on the ceramic board 12 conducts from the ceramic board 12 and the metal case 11 to the accommodating case 60 and then radiates toward the exterior of the projector 1. The heat from the power MOS transistor 42 conducts (is conducted) from the heat sink 45 and the metal case 11 to the accommodating case 60 and radiates (is radiated) to the exterior of the projector 1. The heat from the power MOS transistor 42 to the metal case 11 radiates from the metal case 11 and conducts to the accommodating case, rather than conducting from the metal case 11 to the ceramic board 12. Accordingly, the heat of the power MOS transistor 42 is hard to conduct to the discharge lamp control circuit 20 mounted on the ceramic board 12. This suppresses the increase in the operating temperature of the discharge lamp control circuit 20 to cause the discharge lamp control circuit 20 works normally. Add to it that a longer lifetime of the discharge lamp control circuit 20 is attainable.

Since the electric parts including the high-tension generating circuit 50 mounted on the printed circuit board 13 are located on the surface of the printed circuit board 13 opposite to the surface which has opposed relation to the discharge lamp control circuit 20 and the power MOS transistor 42 and are directed at the exterior of the discharge lamp apparatus 10, the heat in the discharge lamp control circuit 20, the H bridge circuit 21, the power MOS transistor 42 and the metal case 11 cannot easily travel to the electric parts mounted on the printed circuit board 13. Moreover, they can easily be cooled by the cooling fans 70. Accordingly, it is possible to suppress the increase in the operating temperatures of the electric parts mounted on the printed circuit board 13, thus providing the normal operations of the electric parts mounted on the printed circuit board 13. Still moreover, a longer lifetime of each of the electric parts on the printed circuit board 13 is obtainable.

(Second Embodiment)

FIG. 4 shows a second embodiment of the present invention. The substantially same parts as those in the first embodiment are marked with the same reference numerals, and the description thereof will be omitted for brevity.

Although in the first embodiment the electric parts on the printed circuit board 13 are mounted on the surface of the printed circuit board 13 opposite to the surface thereof which has opposed relation to the discharge lamp control circuit 20, the H bridge circuit 21 and the power MOS transistor 42, in the second embodiment the electric parts are mounted on a surface of the printed circuit board 13 which are in opposed relation to the discharge lamp control circuit 20, the H bridge circuit 21 and the power MOS transistor 42. A metal case 75, holding the electric parts of the discharge lamp apparatus, has a deeper configuration as compared with the metal case 11 in the first embodiment.

(Third Embodiment)

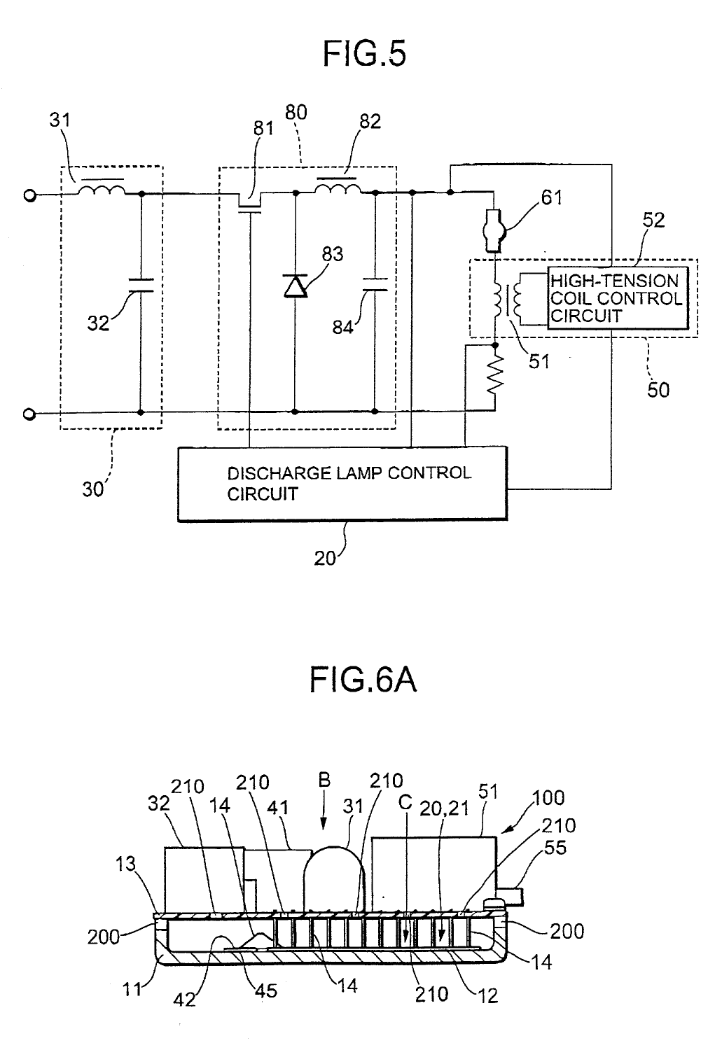

FIG. 5 shows a third embodiment of the present invention. The substantially same parts as those in the first embodiment are marked with the same reference numerals, and the description thereof will be omitted for brevity.

A DC/DC converter 80 of the discharge lamp apparatus according to the third embodiment is a converter for stepping down a power supply voltage, and is made up of a power MOS transistor 81, an inductor 82, a diode 83 and a capacitor 84. Moreover, in the third embodiment, a direct current voltage is made to accomplish the lighting of the discharge lamp 61.

(Fourth Embodiment)

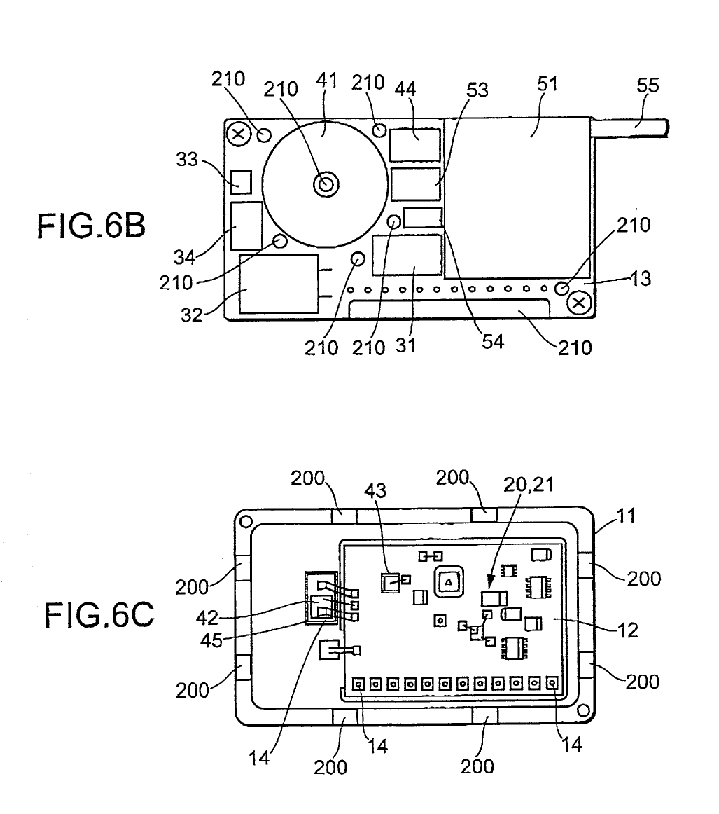

FIGS. 6A to 6C show a fourth embodiment of the present invention.

In the fourth embodiment, a plurality of vent holes 200 are made around an opening portion of the metal case 11 of a discharge lamp apparatus 100 which comes into contact with a printed circuit board 13. In addition, a plurality of vent holes 210 are made to penetrate the printed circuit board 13 including a central portion of a ring-like DC/DC transformer 41. The other construction is the substantially same as that of the discharge lamp apparatus 1 according to the first embodiment, and the same parts are marked with the same reference numerals and the description thereof will be omitted for simplicity.

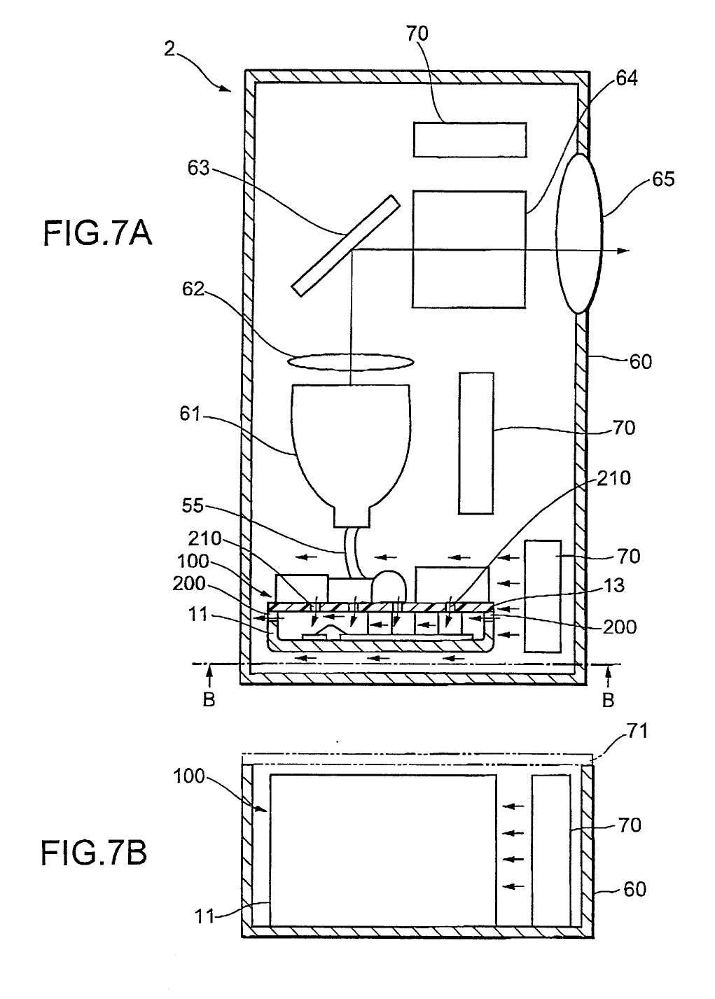

As FIG. 7 shows, in a projector 2 using this discharge lamp apparatus 100, on the operation of cooling fans 70, the wind from the cooling fans 70 passes through the vent holes 200 and 210 from the external side of the metal case 11 to flow into the metal case 11, and then flows out of the metal case 11 through the vent holes 200 and 210.

In this case, even if the printed circuit board 13 covers the opening of the metal case 11, the air passing through the vent holes 200 and 210 and flowing inside and outside the metal case 11 prevents the increase in the operating temperatures of the electric parts constituting the discharge lamp apparatus 2. Moreover, even if the parts constituting the discharge lamp apparatus 2 are located close to each other, the increase in the operating temperatures of the electric parts is efficiently preventable owing to the air flowing inside and outside the metal case 11, thus contributing to the size reduction of the discharge lamp apparatus 2.

In the fourth embodiment, the vent holes are made in both the metal case 11 and printed circuit board 13. On the other hand, it is also appropriate that the vent holes are made in one of the metal case 11 and the printed circuit board 13.

In the fourth embodiment, in the discharge lamp apparatus 2 having the same construction as that of the first embodiment, the vent holes are made in the metal case 11 and the printed circuit board 13. In addition, even if the vent holes are made in the metal case 11 and the printed circuit board 13 of a discharge lamp apparatus having the same construction as that of the second embodiment, the increase in the operating temperatures of the electric parts is also preventable.

In the plurality of embodiments of the present invention described above, the respective electric parts of the discharge lamp apparatus are located either on the internal bottom surface or opening side of the metal case, that is, in a thickness direction of the discharge lamp apparatus forming one of the three-dimensional directions of the discharge lamp apparatus, so it is possible to shorten the lengths of the discharge lamp apparatus in its longitudinal and transverse directions forming the two-dimensional directions. In addition, the discharge lamp apparatus is accommodated within the accommodating case in a state where the longitudinal or transverse direction of the discharge lamp apparatus coincides with the vertical direction and, hence, the projector containing the discharge lamp apparatus is reducible in dimension. Still additionally, it is also appropriate that, depending upon the location of the parts in the accommodating case, the thickness direction of the discharge lamp apparatus is made to coincide with the vertical direction of the projector. Furthermore, in the discharge lamp apparatus according to the present invention, the electric parts other than the power MOS transistor 42 and the high-tension coil 51 can also be located on any one of the internal bottom surface and opening side of the metal case. However, it is preferable that electric parts having a large heat radiation quantity are placed on the internal bottom surface of the metal case while electric parts having a relatively large dimension are situated on the opening side thereof.

In addition, since the heat of the discharge lamp apparatus goes from the metal case of the discharge lamp apparatus to the accommodating case of the projector and radiates from the accommodating case to the exterior of the projector, the reduction of the quantity of the heat radiation from the discharge lamp apparatus to the projector takes place to suppress the temperature increase in the interior of the projector. This can decrease the number of cooling fans to be placed in the projector and reduce the noises to be generated from the cooling fans. Still additionally, the size reduction of the cooling fans or the decrease of the rotational speed of the cooling fans is realizable. Yet additionally, because of a high heat radiation efficiency, it is possible to make smaller the separations between the parts in the accommodating case. This leads to the size reduction of the projector, the decrease of the power consumption and the lowering of the manufacturing cost.

In the plurality of embodiments described above, the discharge lamp apparatus is used for projecting equipment such as a projector. Since the starting voltage of a discharge lamp for use in a projector is low and the specification about noises generated from the projector is generous as compared with that for a discharge lamp apparatus for use in motor vehicles, in the above-described plurality of embodiments the power MOS transistor 42 and the high-tension generating circuit 50 are not covered with a shielding material which can cut off noises. However, the discharge lamp apparatus according to the present invention is also applicable to other than the projecting equipment. In a case in which, in equipment using a discharge lamp apparatus, the starting voltage to be applied from the discharge lamp apparatus to the discharge lamp is high, it is also appropriate that the power device or the high-tension generating circuit is covered with a shielding material.

It should be understood that the present invention is not limited to the above-described embodiments, and that it is intended to cover all changes and modifications of the embodiments of the invention herein which do not constitute departures from the spirit and scope of the invention.

What is claimed is:

1. A discharge lamp apparatus comprising:
a DC/DC converter for stepping up an output voltage by switching an input voltage through the use of a power device;
a high-tension generating circuit including a high-tension coil which, when said output voltage of said DC/DC converter is applied to its primary coil side, starts to light a discharge lamp with a high voltage generated on a secondary coil side;
a discharge lamp control circuit for implementing on/of control of said power device to control power to said discharge lamp; and
a metal case having a blind-end box-like configuration in which electric parts constituting said DC/DC converter, said high-tension generating circuit and said discharge lamp control circuit are located on one of its internal bottom surface and its opening side,
said power device being located on the internal bottom surface of said metal case and said high-tension coil being located on the opening side of said metal case in a state separated from said power device.

2. The apparatus according to claim 1, wherein said discharge lamp control circuit is located on the internal bottom surface of said metal case.

3. The apparatus according to claim 1, further comprising an opening side board located on the opening side of said metal case and made to hold said high-tension coil.

4. The apparatus according to claim 2, further comprising a bottom side board located on the internal bottom surface of said metal case and made to hold said discharge lamp control circuit, and an opening side board located on the opening side of said metal case and made to hold said high-tension coil on its surface opposite to its surface which has opposed relation to said power device and said discharge lamp control circuit.

5. The apparatus according to claim 3, wherein vent holes are made in at least one of said metal case and said opening side board.

6. The apparatus according to claim 5, wherein said DC/DC converter has a ring-like DC/DC transformer, with said DC/DC transformer being located on said opening side board, and vent holes are made in said opening side board positioned at a central portion of said DC/DC transformer.

7. A projecting equipment which projects an image through the use of light emitted from a discharge lamp, comprising:
a discharge lamp apparatus including:
a DC/DC converter for stepping up an output voltage by switching an input voltage through the use of a power device;
a high-tension generating circuit including a high-tension coil which, when said output voltage of said DC/DC converter is applied to its primary coil side, starts to light a discharge lamp with a high voltage generated on a secondary coil side;
a discharge lamp control circuit for implementing on/of control of said power device to control power to said discharge lamp; and
a metal case having a blind-end box-like configuration in which electric parts constituting said DC/DC converter, said high-tension generating circuit and said discharge lamp control circuit are located on one of its internal bottom surface and its opening side,
said power device being located on the internal bottom surface of said metal case and said high-tension coil being located on the opening side of said metal case in a state separated from said power device;
a discharge lamp electrically connected to said discharge lamp apparatus; and
an accommodating case for accommodating said discharge lamp and said discharge lamp apparatus, with said metal case being mounted in said accommodating case.
